(19) United States
(12) Patent Application Publication
(10) Pub. No.: US 2026/0242008 A1
(43) Pub. Date: Aug. 20, 2026

(54) Baffle/Reinforcement Inserts With Directional Expansion Sealing (DES) and Method of Manufacturing

(71) Applicant: L & L PRODUCTS, Shenyang, Liaoning (CN)

(72) Inventors: Jun Wu, Shenyang (CN); Marc Neel, Shenang (CN); Peter Cate, Shenang (CN); Andy Wei, Shenang (CN)

(21) Appl. No.: 19/489,622

(22) PCT Filed: Jun. 7, 2023
(86) PCT No.: PCT/CN2023/099007

§ 371 Date: Dec. 3, 2025

(51) Int. Cl. B62D 29/04; B32B 3/26; B32B 3/28; B32B 7/12; B32B 27/10; B32B 27/34; B62D 27/02; B62D 29/00

(52) U.S. Cl. CPC B62D 29/048; B32B 3/266; B32B 3/28; B32B 7/12; B32B 27/10; B32B 27/34; B62D 27/026; B62D 29/00

(57) ABSTRACT

A baffle assembly for use in a cavity including a first substrate including; a second substrate and an adhesive layer that is activatable disposed between the interior first surface and the interior second surface; and a clip member, the clip member disposed on the exposed surface of the first or second substrate adapted to hold the first substrate, the second substrate, and the adhesive layer together prior to the activation of the adhesive and adapted to hold the baffle assembly in the cavity.

### FIELD OF THE INVENTION

The present invention relates generally to an insert for use in vehicle frames, more particularly a unique insert assembly of baffle/reinforcement inserts with directional expansion sealing (DES) and method of manufacturing thereof in a sandwich configuration.

### BACKGROUND OF THE INVENTION

Vehicles can have relatively long spans in the chassis frame or in the Body In White (BIW) that may require additional support and/or baffling inserts. It is well known that excessive tooling costs can be particularly concerning for vehicles that have relatively low annual volumes, for example less that of about 40,000 units. It is recognized that it is desirable to minimize tooling costs for many items such as baffles/reinforcements, while still maintaining the performance (e.g. weight, durability, stiffness, etc . . . ) of the low volume vehicles. It is also recognized that it may be desirable to control the flow of any adhesive in the system, especially for expandable adhesives.

### SUMMARY OF THE INVENTION

The present teachings meet one or more of the above needs by the improved insert assembly and methods described herein.

In one aspect, the present teachings pertain to a baffle assembly for use in a cavity comprising: a first substrate including an exposed first surface, an interior first surface, and a first thickness therebetween; a second substrate including an exposed second surface, an interior second surface, and a second thickness therebetween; an adhesive layer that is activatable disposed between the interior first surface and the interior second surface; and a clip member, the clip member disposed on the exposed surface of the first or second substrate adapted to hold the first substrate, the second substrate, and the adhesive layer together prior to the activation of the adhesive and adapted to hold the baffle assembly in the cavity.

In a further aspect, the teachings herein are directed to one or more aspect of the assembly as described above, wherein the clip member includes a joining feature that is adapted to secure a second component to the baffle assembly; wherein the second component is a second baffle assembly; wherein at least one of the first substrate, second substrate, or the adhesive layer includes localized through holes; wherein the first substrate, the second substrate, or both include one or more holes to allow fluid flow between the respective exposed second surfaces before the adhesive layer is activated or after it activated; wherein the clip member includes at least one anti-rotation feature; wherein the first substrate, second substrate, or both are composed of a polymeric material; wherein the first substrate, second substrate, or both are composed of a paper material; wherein the adhesive layer is composed of an expandible adhesive material; wherein the expandable adhesive flows only outward towards a wall of the cavity from an peripheral edge of first substrate and the second substrate; wherein the first substrate, second substrate, or both include at least one through hole to allow the expandible adhesive to flow through during the activation process; wherein the adhesive layer is a multi-layered adhesive assembly that includes at least two(2) disparate adhesives compositions or layers; wherein the at least two(2) disparate adhesives compositions or layers include a first adhesive layer comprised of an expandable adhesive material and a second layer comprised of a structural adhesive material; wherein the adhesive layer is a multi-layered adhesive and substrate assembly that includes at least three(3) disparate layers of adhesives and extra substrates; wherein the first substrate, second substate, or both comprise a multi-layered substrate assembly that includes at least two(2) disparate substrate compositions or layers; wherein the at least two(2) disparate substrate compositions or layers include a first polymeric layer comprised of a nylon material and a second layer comprised of a paper material; wherein the nylon material is reinforced with a fiber and the paper material is a flat stock or a corrugated cardboard.

In second aspect, the present teachings pertain to a method of manufacturing an assembly (as described herein) comprising: A method of manufacturing a baffle assembly for use in a cavity, comprising the steps of: providing a first substrate including an exposed first surface, an interior first surface, and a first thickness therebetween; providing a second substrate including an exposed second surface, an interior second surface, and a second thickness therebetween; providing an adhesive layer that is activatable; providing a clip member, adapted to hold the assembled baffle assembly in the cavity; lay up the adhesive layer on the interior first surface of the first substrate; lay up the second substate onto the adhesive layer, opposite of the first substrate; laying up on the second interior surface creating a baffle sub-assembly; cutting the baffle sub-assembly to a desired shape, including at least one hole for receipt of a portion of the clip member; assembling the clip member to the baffle sub-assembly to complete the baffle assembly.

In a further aspect, the teachings herein are directed to one or more aspect of the insert assembly manufacturing as described above, wherein the cutting to the desired shape step occurs before providing the first and second substrates and the adhesive layer; wherein at least one of the provided first substrate, second substrate, and adhesive layer are in rolls and the laying up steps are in a continuous process; further including the steps of providing a multi-layered adhesive assembly for the adhesive layer; wherein the cutting step is performed with a cutting process selected from one or more of a die cutting tool, a water jet cutter, or a laser cutter.

### DESCRIPTION OF THE DRAWINGS

FIG. 1 is a perspective view of an exemplary vehicle according to the present invention.

FIG. 2 is a perspective view of an exemplary Baffle/reinforcement insert with directional expansion sealing according to the present invention.

FIG. 3 is a perspective view of an exemplary Baffle/reinforcement insert with an additional connected insert according to the present invention.

FIG. 4 is a perspective view of another exemplary Baffle/reinforcement insert with directional expansion sealing according to the present invention.

FIG. 5 is a top view of the insert of FIG. 3 in-situ of section A-A of FIG. 1

FIG. 6 is a bottom view of FIG. 5 with the adhesive expanded.

FIG. 7 is a perspective view of an exemplary Baffle/reinforcement insert subassembly.

FIG. 8 is an exploded view of the subassembly of FIG. 7.

FIG. 9 is a perspective view of an exemplary clip member according to the present invention.

FIG. 10 is a schematic view of an exemplary manufacturing line according to the present invention.

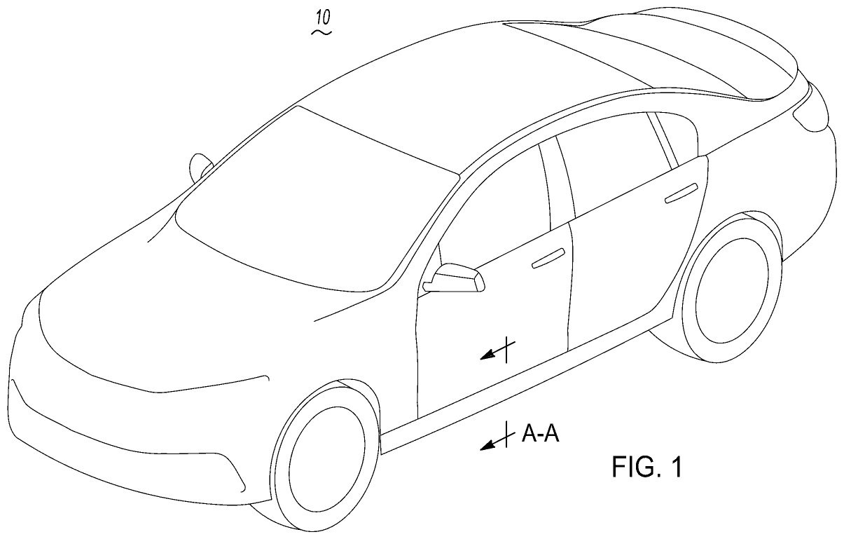

### DETAILED DESCRIPTION

The explanations and illustrations presented herein are intended to acquaint others skilled in the art with the invention, its principles, and its practical application. The specific embodiments of the present invention as set forth are not intended as being exhaustive or limiting of the invention. The scope of the invention should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein may generally relate to the inventive baffle insert assemblies used in the cavities of structural frame assemblies (in an automobile chassis or BIW). The inventive reinforcement insert assemblies including a somewhat flat multi-layer baffle with a clipping member that facilitates securing the assembly to the cavity and keeps the layers (sandwich configuration) of the assembly together (at least prior to activation of the adhesive layer).

### Vehicle Frame Assembly (Chassis or BIW) 20

Vehicle frame assemblies 20 (of a vehicle 10) generally comprise a frame cavity 22 with an inner frame wall 24 and an outer frame wall 26. These assemblies 20 may be part of a vehicle chassis frame or as part of a body-in-while. These may be formed of a variety of materials. The frame members may have certain members formed of one material and other frame members formed of a second material. The frame assemblies maybe formed of polymeric materials (e.g., polyurethane, polyamide, polypropylene), metallic materials (e.g., aluminum, steel, magnesium), fibrous materials (glass fibers, carbon fibers, aramid fibers), or some combination of these materials. To the extent that the assemblies 20 (or the baffle assembly 30) utilize an adhesive, the adhesive may be an acrylate-based adhesive, an epoxy-based adhesive, polyurethane-based adhesive, polyimide-based adhesives, or some combination thereof. The adhesive may be a one or two component reactive adhesive. The adhesive may be in the form of a film or tape. The adhesive may be a hot melt adhesive. The adhesive may be a foaming adhesive. The adhesive may be activated (e.g., to cure, foam, adhere or the like) by a stimulus. The adhesive may activate as a result of combining two components. The adhesive may be further detailed and described in the sections below.

### Baffle Assembly 30—Generally

The baffle assembly 30 with three or more layers (40, 50, 60) including at least one adhesive layer 50, a first substrate layer 40, a second substrate layer 60 and clip member 70 that ties the layers 40, 50, 60 together and to the vehicle frame assembly 20 is the focus of the present invention. It is contemplated that the baffle assembly 30 functions to provide at least a level of local sealing and/or reinforcement to the frame assembly 20. It is contemplated that the use of a third layer (whether polymer or cardboard) additionally has the benefit of protecting the adhesive layer during storage/transport. It is also contemplated that the baffle assembly 30 may include a second or third or more additional components 36 tied together by a clip connecting member 72 that facilitates the joining of one clip member 70 to another. It is contemplated that the additional component 36 could be another baffle assembly 30 or a baffle subassembly 34 or something different such as a block of expandable foam or the like. It is also contemplated that the baffle assembly 30 may include additional substrate layers and/or additional adhesive layers. It is contemplated that the substrate layers are generally flat/planar and provide some level of directional control for any expansion of the adhesive layer 50. It is contemplated that the use of a layer on each side of the adhesive layer 50 (whether polymer or cardboard) also has the benefit of protecting the expandable adhesive layer during storage/transport. The baffle assembly 30 of the present invention may be installed into an automotive vehicle although it may be employed for other articles of manufacture such as boats, buildings, furniture, storage containers or the like. The baffle may be used to seal and/or baffle a variety of components of an automotive vehicle including, without limitation, body components (e.g., panels), frame components (e.g., hydroformed tubes), pillar structures (e.g., A, B, C or D-pillars), bumpers, roofs, bulkheads, instrument panels, wheel wells, floor pans, door beams, hem flanges, vehicle beltline applications, doors, door sills, rockers, decklids, hoods or the like of the automotive vehicle. Each of the respective components of this assembly 30 are described in further detail in the subsequent paragraphs.

### First Substrate Layer 40

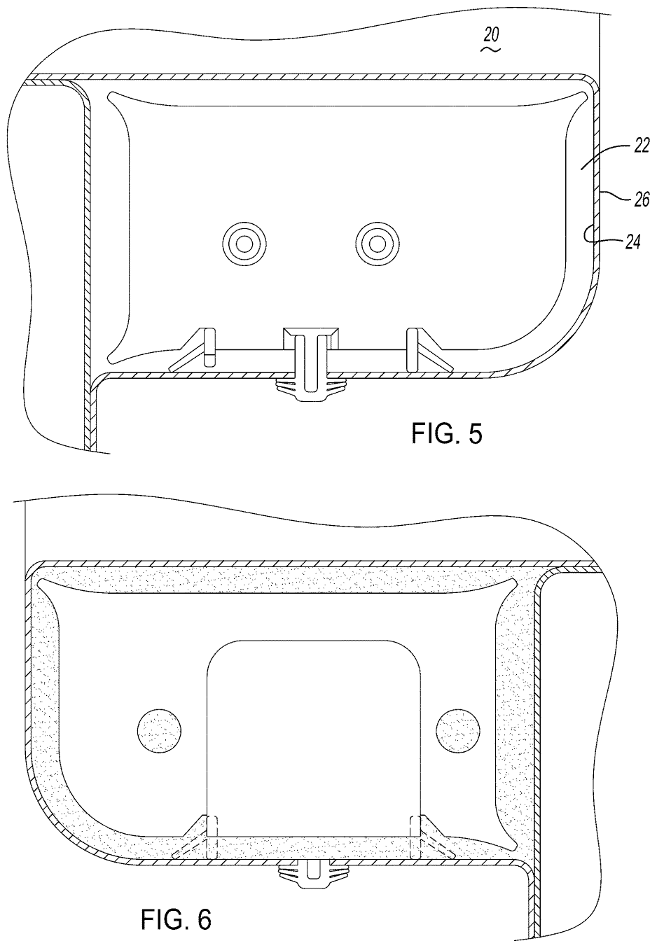

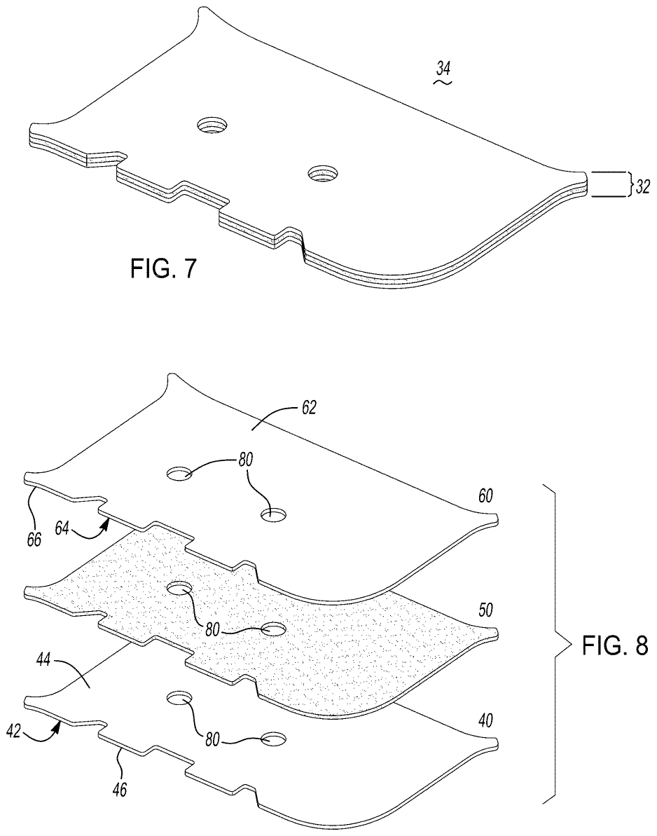

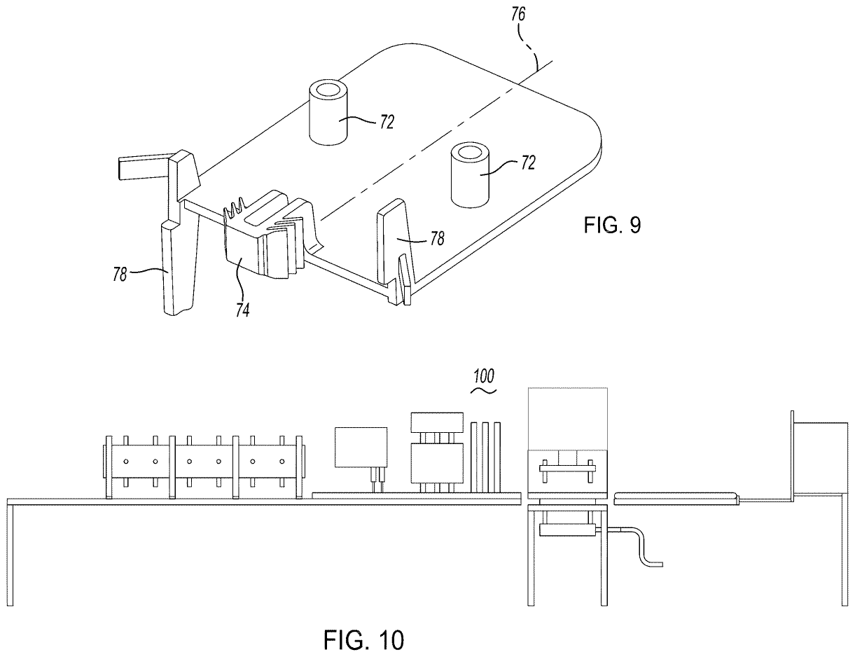

It is contemplated that first substrate layer 40 the second substrate layer 60 may be duplicates of one another or could be completely different and may be interchangeable in the assembly 30. The first substrate layer 40 functions to be an outside wall of the assembly 30 (exposed first surface 42), providing a surface for the adhesive layer to sit upon (interior first surface 44), and having a first wall thickness 46 therebetween. First substrate layer 40 may be composed of a single layer of material or a composite of many materials but is preferably a mostly flat sheet that can be used for one wall of the assembly 30. It is contemplated that layer 40 is a flat blank that can come as a pre-formed component, a part cut from a sheet, or a part cut from a roll. In a preferred embodiment, the layer 40 comes in sheet or roll form, to minimize any tooling requires for the whole assembly 30. Preferred compositions include polymeric materials such as nylon, fiber filled nylon, thermoplastics, thermosets, and any polymeric materials with a melting point greater than about 200 degrees Celsius. It may also be preferred to be composed of natural materials such as paper or cardboard. First Thickness 46 may be as small as 0.1 mm or as large as 20 mm, preferably ranging from about 0.5 mm to 10 mm, more preferably from about 1 mm to 5 mm. The first substrate layer 40 may have a shape that complements the shape of the frame cavity 22 that it will be placed in. It may include one or more through holes for facilitating the use of one or more attachment features of the clip member 70. In one preferred embodiment, there are no additional through holes in the exposed surface 42, such that the adhesive only can flow (or expand) from a peripheral edge 32 of the assembly 30. It also may include holes 80 that allow a portion of the adhesive layer 50 to be exposed to the rest of the frame cavity 22 and depending upon any expansion of the adhesive used, may aid in securing the layers together, for example where the adhesive expands and mushrooms past the thickness 46 and onto the exposed surface 42 as shown in FIG. 6.

### Second Substrate Layer 60

As stated above, it is contemplated that first substrate layer 40 the second substrate layer 60 may be duplicates of one another or could be completely different and may be interchangeable in assembly 30. The second substrate layer 60 functions to be an outside wall of the assembly 30 (exposed second surface 62), providing a surface for the adhesive layer to sit upon (interior second surface 64), and having a second wall thickness 66 therebetween. Like the First substrate layer 40, the second substrate layer 60 may be composed of a single layer of material or a composite of many materials but is preferably a mostly flat sheet that can be used for one wall of the assembly 30. It is contemplated that layer 60 is a flat blank that can come as a pre-formed component, a part cut from a sheet, or a part cut from a roll. In a preferred embodiment, the layer 60 comes in sheet or roll form, to minimize any tooling required for the whole assembly 30. Preferred compositions include polymeric materials such as nylon, fiber filled nylon, thermoplastics, thermosets, and any polymeric materials with a melting point greater than about 200 degrees Celsius. In the case where lower bake temperatures will be seen by the assembly 30 are possible, it may be possible, and preferable, to utilize polymeric materials with a melting point below about 200 degrees Celsius, such as Polycarbonate/acrylonitrile butadiene styrene, Acrylonitrile Butadiene Styrene, and polypropylene. It may also be preferred to be composed of natural materials such as paper or cardboard. Second Thickness 66 may be as small as 0.1 mm or as large as 20 mm, preferably ranging from about 0.5 mm to 10 mm, more preferably from about 1 mm to 5 mm. The second substrate layer 60 may have a shape that complements the shape of the frame cavity 22 that it will be placed in. It may include one or more through holes for facilitating the use of one or more attachment features of the clip member 70. It is also contemplated that the clip member 70 is disposed on the exposed second surface 62. In one preferred embodiment, there are no additional through holes 80 in the exposed surface 62, such that the adhesive only can flow (or expand) from a peripheral edge 32 (or through holes 80 in the layers 40, 60) of the assembly 30, also referred to as directional expansion sealing (DES). It also may include holes 80 that allow a portion of the adhesive layer 50 to be exposed to the rest of the frame cavity 22 and depending upon any expansion of the adhesive used, may aid in securing the layers together, for example where the adhesive expands and mushrooms past the thickness 66 and onto the exposed surface 62 as shown in FIG. 6.

### Clip Member 70

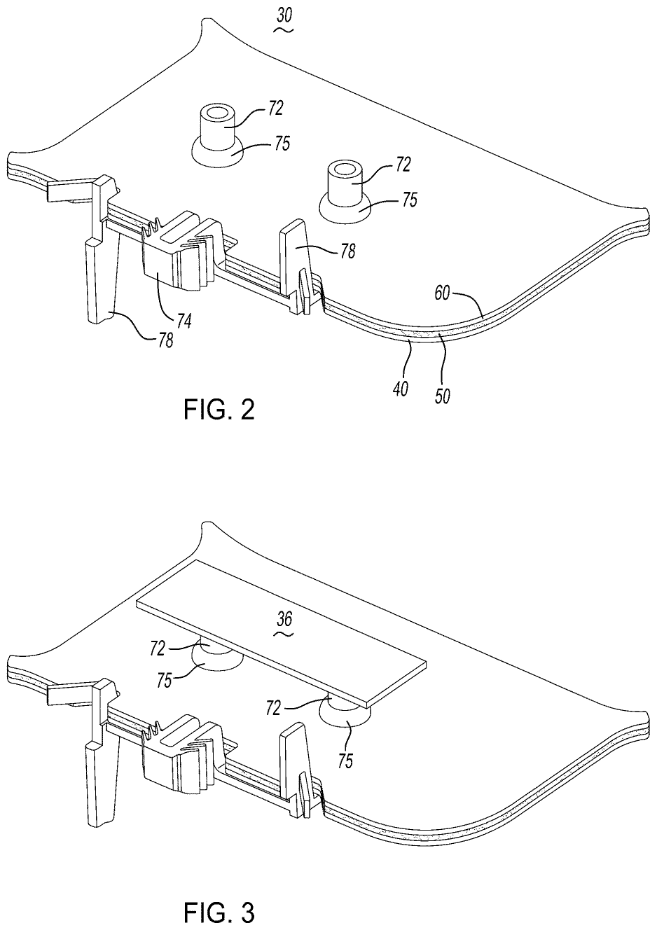

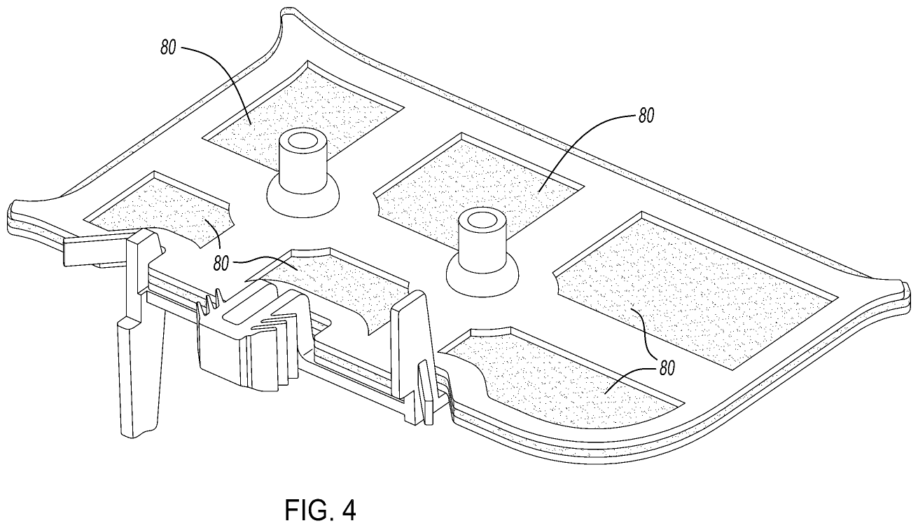

The substrates 40, 60 and adhesive layer 50 may require that one or more of the components (e.g., clip member 70) at least temporarily holds the layers (40,50,60) in place/together until the adhesive is activated in assembly 30. Additionally, member 70 may function to adhere to a second baffle assembly 30 and/or to adhere to a portion of the frame cavity 22. In the present invention, the preferred way to provide this functionality is via a clip member 70 with the following structural components. As an illustrative example, referring to FIGS. 2 and 3 a clip member 70 is contemplated with one or more clip connecting members 72, with the dual function holing the layers 40,50, and 60 together (either as a post with a locking washer 75 or as a x-mass tree not shown) and providing an optional means to attach a second baffle assembly 30 to the first. Additionally, clip member 70 includes a cavity connecting member 74 that provides a means to connect the baffle assembly 30 to or through a frame cavity 22 wall. In an illustrative example seen in the figures, the cavity connecting member 74 may be in the form of an x-mass tree clip. In a preferred embodiment, the clip member 70 is at least partially symmetrical about a central axis 76 such that it may function for both baffle assemblies 30 for either the right- or left-hand sides of the vehicle 10. It is also contemplated that the clip member includes one or more anti-rotation legs 78, which examples can be seen in the figures.

### Adhesive Layer 50

The adhesive material may be a two-part material that activates (e.g., cures, foams, or some combination thereof) when the two parts are combined. Activation may occur at room temperature or at an elevated activation temperature. It is also contemplated that the adhesive layer is a multi-layered adhesive assembly that includes at least two(2) disparate adhesives compositions or layers, for example where one composition is an expandible adhesive with a first expansion value and a second is an expandable with a disparate second expansion value. It is also contemplated that the second adhesive material in a non-expandable structural adhesive and may contribute to the structure and stiffness of the assembly 30.

It is contemplated and preferred that the adhesive material used in the adhesive layer be an expanding sealing material(s), more particularly, an expanding material that expands due to application of heat or energy. After placement of the baffle into a cavity, the expandable sealing materials may expand according to a predetermined set of conditions. For example, exposure to certain levels of heat may cause the expandable materials to expand. The volumetric expansion of the expandable materials may vary depending upon the sealing and/or baffling needs of a particular cavity. The expandable material may expand to fill the vehicle cavity and cover the voids in the interior body portion of the carrier. The expandable material may expand at least about 100%. The expandable material may expand less than about 2000%. The expandable material may expand at least about 500%, at least about 1000%, or more. The expandable material may expand less than about 1000% or even less than about 500%. The adhesive material may be an epoxy-based material such as those disclosed in U.S. Pat. Nos. 5,884,960; 6,348,513; 6,368,438; 6,811,864; 7,249,415; and U.S. Patent Publication No. 2004/0076831, hereby incorporated by reference in their entirety for all purposes. The adhesive may include one or more phosphate ester-based components such as those disclosed in U.S. Pat. No. 10,550,220 hereby incorporated by reference in its entirety for all purposes. The expandable sealing materials may be generally dry to the touch or tacky and may be shaped in any form of desired pattern, placement, or thickness, but is preferably of substantially uniform thickness. Though other heat-activated materials are possible for expandable sealing materials, a preferred heat activated material is an expandable polymer or plastic, and preferably one that is foamable. The expandable sealing materials may be relatively high expansion foams having a polymeric formulation that includes one or more of an epoxy resin, an acetate (e.g. ethylene vinyl acetate), a thermoplastic polyether, an acrylate and/or a methacrylate (e.g., a copolymer of butyl acrylate and methyl acrylate), an epoxy/elastomer adduct, and one or more fillers (e.g., a clay filler, and/or a nanoparticle-containing filler). Preferred thermally expandable materials are disclosed in U.S. Pat. Nos. 7,313,865; 7,125,461; and 7,199,165 incorporated by reference herein for all purposes. For example, and without limitation, the foam may also be an EVA/rubber-based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules. Suitable expandable materials include those available from L&L Products, Inc. under the designations L7220, L2821, L1066, L205, L2010, L2105, L2108A, L2806, L2811, L4200, L4141, L4161, L4315, L5510, L5520, L5540, L5600, L5601, L7102, and L7104. The expandable materials may be die cut extruded sheets of material or in roll form. In a preferred embodiment, the adhesive layer 50 is similar in shape (e.g., peripheral shape) to the first substrate member 40, second substrate member 60, or both.

### Method of Manufacturing

It is contemplated that one important aspect of the present invention is the ability to manufacture the baffle assembly 30 as described above with minimal tooling and a straightforward process. An illustrative manufacturing line 100 can be seen in FIG. 10. It is contemplated that the method may comprise the steps of: providing a first substrate in sheet form including an exposed first surface 42, an interior first surface 44, and a first thickness 46 therebetween; providing a second substrate 60 in sheet form including an exposed second surface 62, an interior second surface 64, and a second thickness 66 therebetween; providing an adhesive layer 50 in sheet form that is activatable; providing a clip member 70, adapted to hold the layers 40,50, and 60 together and to hold the assembled baffle assembly 30 in the cavity; laying up the adhesive layer 50 on the interior first surface 44 of the first substrate 40; laying up the second substate 60 onto the adhesive layer 50, opposite of the first substrate 40; laying up on the second interior surface creating a baffle sub-assembly 34; cutting the baffle sub-assembly to a desired shape, including at least one through hole 80 for receipt of a portion of the clip member 70; assembling the clip member 70 to the baffle sub-assembly 34 to complete the baffle assembly 30. It is also contemplated that the cutting to the desired shape step occurs before providing the first and second substrates 40, 60 and the adhesive layer 50. It is also possible that at least one of the provided first substrate 40, second substrate 60, and adhesive layer 50 are in rolls and the laying up steps are in a continuous process. It is further contemplated that further including the step of providing a multi-layered adhesive assembly for the adhesive layer and the cutting step is performed with a cutting process selected from one or more of a die cutting tool, a water jet cutter, or a laser cutter.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize, however, that certain modifications would come within the teachings of this invention. Therefore, the following claims should be studied to determine the true scope and content of the invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### ELEMENT NUMBERS

10 Vehicle
20 Vehicle Frame Assembly
22 Frame Cavity
24 Inner Frame Wall
26 Outer Frame Wall
30 Baffle Assembly
32 Peripheral Edge
34 Baffle Sub-assembly
36 Additional Component(s)
40 First Substrate Member
42 Exposed First Surface
44 Interior First Surface
46 First Wall Thickness
50 Adhesive Layer
60 Second Substrate Member
62 Exposed Second Surface
64 Interior Second Surface
66 Second Wall Thickness
70 Clip Member
72 Clip Connecting Member
74 Cavity Connecting Member
75 Lock Washer
76 Central Axis
78 Anti-rotation Leg
80 Through Hole
100 Manufacturing Line

1. A baffle assembly for use in a cavity comprising:
a first substrate including an exposed first surface, an interior first surface, and a first thickness therebetween;
a second substrate including an exposed second surface, an interior second surface, and a second thickness therebetween;
an adhesive layer that is activatable disposed between the interior first surface and the interior second surface; and
a clip member, the clip member disposed on the exposed surface of the first or second substrate adapted to hold the first substrate, the second substrate, and the adhesive layer together prior to the activation of the adhesive and adapted to hold the baffle assembly in the cavity.

2. The baffle assembly of claim 1, wherein the clip member includes a joining feature that is adapted to secure a second component to the baffle assembly.

3. The baffle assembly of claim 2, wherein the second component is a second baffle assembly.

4. The baffle assembly of claim 1, wherein at least one of the first substrate, second substrate, or the adhesive layer includes localized through holes.

5. The baffle assembly of claim 1, wherein the first substrate, the second substrate, or both include one or more holes to allow fluid flow between the respective exposed second surfaces before the adhesive layer is activated or after it activated.

6. The baffle assembly of claim 5, wherein the clip member includes at least one anti-rotation feature.

7. The baffle assembly of claim 1, wherein the first substrate, second substrate, or both are composed of a polymeric material.

8. The baffle assembly of claim 1, wherein the first substrate, second substrate, or both are composed of a paper material.

9. The baffle assembly of claim 1, wherein the adhesive layer is composed of an expandible adhesive material.

10. The baffle assembly of claim 9, wherein the expandable adhesive flows only outward towards a wall of the cavity from an peripheral edge of first substrate and the second substrate.

11. The baffle assembly of claim 9, wherein the first substrate, second substrate, or both include at least one through hole to allow the expandible adhesive to flow through during the activation process.

12. The baffle assembly of claim 1, wherein the adhesive layer is a multi-layered adhesive assembly that includes at least two(2) disparate adhesives compositions or layers.

13. The baffle assembly of claim 12, wherein the at least two (2) disparate adhesives compositions or layers include a first adhesive layer comprised of an expandable adhesive material and a second layer comprised of a structural adhesive material.

14. The baffle assembly of claim 1, wherein the adhesive layer is a multi-layered adhesive and substrate assembly that includes at least three (3) disparate layers of adhesives and extra substrates.

15. The baffle assembly of claim 1, wherein the first substrate, second substate, or both comprise a multi-layered substrate assembly that includes at least two(2) disparate substrate compositions or layers.

16. The baffle assembly of claim 15, wherein the at least two(2) disparate substrate compositions or layers include a first polymeric layer comprised of a nylon material and a second layer comprised of a paper material.

17. The baffle assembly of claim 16, wherein the nylon material is reinforced with a fiber and the paper material is a flat stock or a corrugated cardboard.

18. A method of manufacturing a baffle assembly for use in a cavity, comprising the steps of:
(i) providing a first substrate including an exposed first surface, an interior first surface, and a first thickness therebetween;
(ii) providing a second substrate including an exposed second surface, an interior second surface, and a second thickness therebetween;
(iii) providing an adhesive layer that is activatable;
(iv) providing a clip member, adapted to hold the assembled baffle assembly in the cavity;
(v) laying up the adhesive layer on the interior first surface of the first substrate;
(vi) laying up the second substate onto the adhesive layer, opposite of the first substrate; laying up on the second interior surface creating a baffle sub-assembly;
(vii) cutting the baffle sub-assembly to a desired shape, including at least one hole for receipt of a portion of the clip member;
(viii) assembling the clip member to the baffle sub-assembly to complete the baffle assembly.

19. The method of claim 18, wherein the cutting to the desired shape step occurs before providing the first and second substrates and the adhesive layer.

20. The method of claim 18, wherein at least one of the provided first substrate, second substrate, and adhesive layer are in rolls and the laying up steps are in a continuous process.

21. (canceled)

22. (canceled)
